(19) United States
(12) Patent Application Publication
(10) Pub. No.: US 2023/0176843 A1
(43) Pub. Date: Jun. 8, 2023

(54) App Store Information Page Customization

(71) Applicant: Apple Inc., Cupertino, CA (US)

(72) Inventors: Timothy Huang, San Mateo, CA (US); Nicholas Kistner, San Francisco, CA (US)

(21) Appl. No.: 18/062,081

(22) Filed: Dec. 6, 2022

Related U.S. Application Data
(60) Provisional application No. 63/265,012, filed on Dec. 6, 2021.

(51) Int. Cl. G06F 8/61; G06Q 30/0201

(52) U.S. Cl. CPC G06F 8/61; G06Q 30/0201

(57) ABSTRACT

Techniques for digital asset classification are described. One or more holiday score are assigned to a set of digital media assets. The one or more holiday scores are calculated based on weighted holiday metrics determined based on characteristics of the set of digital assets. A holiday classification is assigned based on the one or more holiday score, and the set of digital media assets are provided for presentation in accordance with the holiday classification.

### TECHNICAL FIELD

Embodiments described herein relate to presentation of software applications. More particularly, embodiments described herein relate to providing custom visual representations of software applications.

### BACKGROUND

In recent years, downloading of software applications (or “apps”) from an on-line app store has become a popular method for obtaining software applications. An on-line app store allows users to download a software application onto their device, such as a desktop computer or laptop computer, smartphone, or other mobile device, and then install the app on their device. Prior to downloading an app, users often find apps within the app store. In response to a user search, the app store may provide results to the user with a particular set of representative data, such as an icon, screenshot, text description, and the like.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1 illustrates, in block diagram form, network by which an app store is accessed by client devices, according to one or more embodiments.

FIG. 2 illustrates an example of variations of a product page provided to different users, in accordance with one or more embodiments.

FIG. 3 illustrates an example of installation of an app from different variations of a product page, in accordance with one or more embodiments.

FIG. 4 illustrates, in flowchart form, a technique for providing variations on a product page to different users, in accordance with one or more embodiments.

FIG. 5 illustrates, in flow diagram form, a technique for providing custom product pages in an app store, in accordance with one or more embodiments.

FIG. 6 illustrates, in flowchart form, a technique for providing custom product pages in an app store, in accordance with one or more embodiment.

FIG. 7 illustrates a simplified functional block diagram of an illustrative programmable electronic device, in accordance with an embodiment.

### DETAILED DESCRIPTION

This disclosure pertains to systems, methods, and computer readable media for providing multiple variations of a presentation of an app within an app store according to one or more embodiments. In particular, embodiments described herein relate to a technique for providing multiple treatments of an app in an app store such that the subsequently downloaded app is presented consistently with the treatment from which the app was downloaded in the app store.

This disclosure also pertains to systems, methods, and computer readable media for providing multiple variations of a presentation of an app within an app store according to one or more embodiments. In particular, embodiments described herein relate to a technique for providing custom variations on product pages for a particular app. In particular, embodiments described herein relate to a technique for determining, based on a triggering event, a particular version of an app information to present to a user in an app store. The particular version may be selected based on contextual information surrounding the triggering event such that the selected version has some degree of relevance to the user experience prior to the navigation to the app information page.

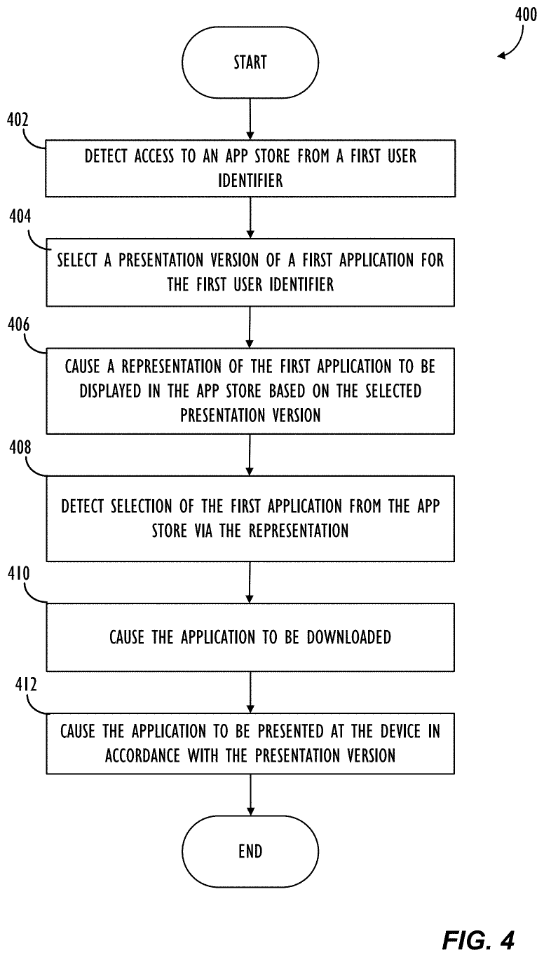

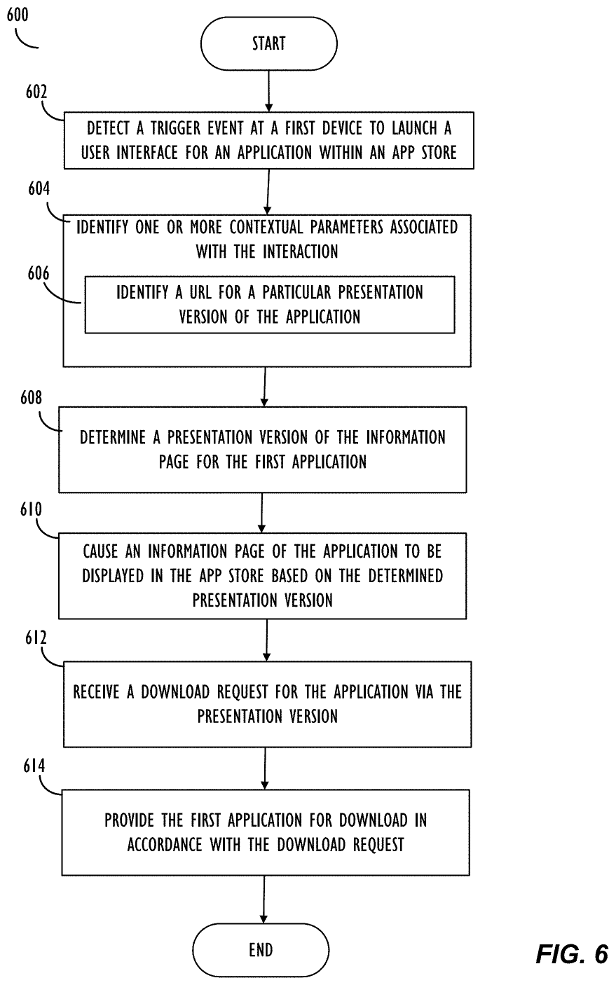

The embodiments described herein can operate within and interface with the environment and context of an app store from which one or more users, using client devices, can search for and download one or more applications (also referred to as apps). An app store 100 can include one or more servers, such as servers 101, 102, and 103, that can provide the functionality described herein. For example, server(s) 101 can interface with a client device to implement the methods of FIGS. 4 and 6 to generate and/or provide custom app information pages, and/or customized app content for presentation at one or more client devices, such as client devices 107 and 109 which can take a variety of different forms (e.g., tablet computer such as an iPad, smartphone such as an iPhone, laptop computer, desktop computer, network media player such as an Apple TV, game/entertainment system, or other consumer electronic device). The client devices 107 and 109 can be coupled to the app store 100 by one or more networks 105, such as the Internet, which provides for the data communication between the client devices and the app store so that the client devices can send search queries to the app store, receive search results and send requests to download one or more apps and then receive the downloads of the one or more apps. The server(s) 101, in one embodiment, can create the data structures used in providing custom app information pages and/or custom representation of apps to a particular subset of users (e.g. an association of an app representation with particular user or device identifiers), and store those data structures in storage 104 for later use by server(s) 102 which can be configured to receive search queries from client devices and then perform searches of one or more data structures in order to provide a consistent view of representations of the apps within the app store.

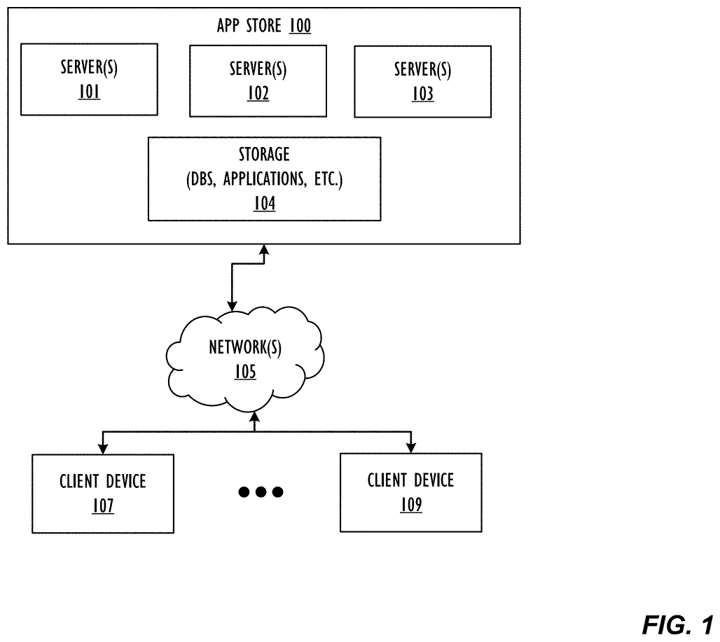

An app store, such as the app store shown in FIG. 1 can collect information about queries used to search for applications and about downloads that result from a user's selection of an app shown in the search results produced by a search query. This information can be collected in logs maintained by the app store which record the queries that were used and the downloads that resulted from these queries. In one embodiment, the one or more servers 102 can maintain a record during a user's search session of the queries used and the selections made from the search results of those queries, and this record can be recorded in one or more logs. In one embodiment, the app store can keep track of user's selections which seek further information about a particular application without necessarily downloading the application in addition to keeping track of downloads that resulted from a particular search query. In another embodiment, the app store can keep track of only downloads that resulted from search results in order to limit the amount of information which may be relevant; in other words, downloads may be considered more relevant and more important information than user selections for more information about applications which do not result in downloads.

The servers (101, 102, 103) and/or the client devices 107 and 109 can also include memory for storing and/or retrieving apps from the app store 100. According to some embodiments, the client devices 107 and 109 may provide access to the app store 100, on which multiple applications may be hosted. The app store 100 may provide a particular treatment for an app information page within the app store for a particular app, to a particular user. That is, a view of an app information page from client device 107 may differ from a view of the app information page from client device 109. In some embodiments, the client device 107 and 109 may obtain the same binary download package and the app store 100 may transmit metadata indicating a particular treatment to use for the application such that the user experience maintains consistency from the app information page presented to the user in the app store 100.

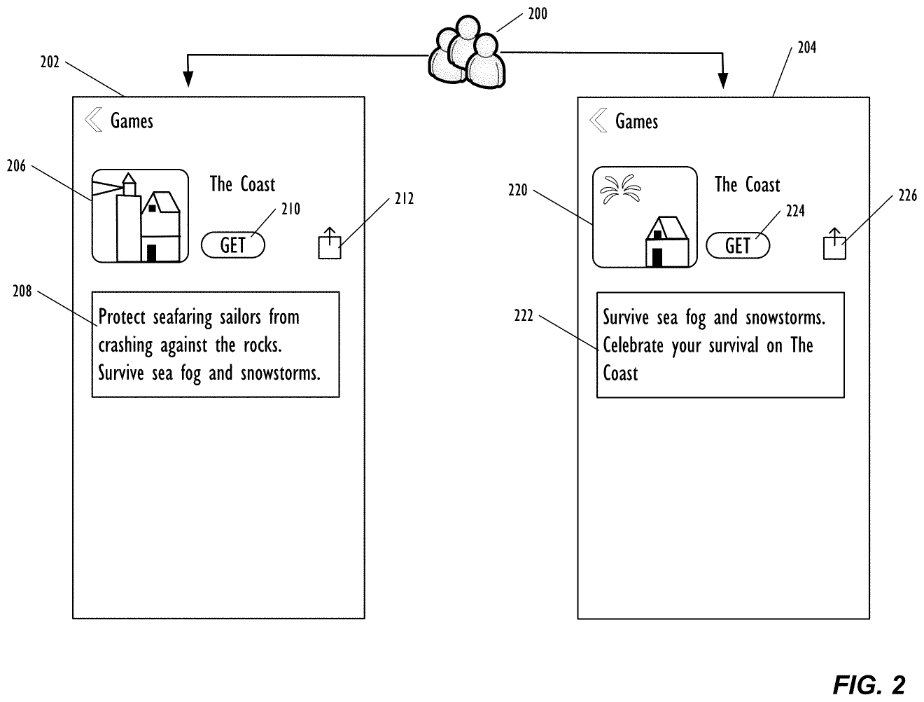

FIG. 2 shows a diagram of an example of variations of a representation of an application as it is presented to different users. In some embodiments, an app developer may wish to provide multiple representations of an app for download by different users. For example, a developer may wish to provide an application with different treatments for different users. As a result, according to some embodiments, a developer can track which treatment in the app store attracts more users. In some embodiments, the different treatments may be encoded into the binary of the app such that depending upon which visual representation a user responds to in the app store, the app can be downloaded and launched at the user device such that it is presented in a consistent manner as the visual treatment from which the user obtained the app in the app store.

According to one or more embodiments, the app store may provide different treatments 202 and 204 of the app within the app store to different users 200. For example, as shown in FIG. 2, if a first user searches for a game called “The Coast” within the app store, they may see the app information page 202, which includes a first icon 206 and description 208. In some embodiments, the treatments comprise a plurality of presentations versions of the information page for the app. Accordingly, while treatment 202 is presented to some users of the app store, other users 200 may be provided with a second treatment 204. For purposes of the example, the app store information page of the second treatment 204 includes a second icon 220 and second description 222 that differs from the icon 206 and description 208 provided in the first treatment of the app information page 202.

The plurality of presentation versions may include a default presentation version and one or more updated variations. In some embodiments, other information may be unique to a particular treatment, such as screenshots, media items (video content, graphic content, etc.). The treatment provided to a particular user may be selected at random, or may be predefined. Moreover, in some embodiments, a predefined share of users 200 may be provided a particular treatment, for example based on traffic allocation. As an example, 80% of users 200 may view a default treatment, whereas 20% of users 200 may view one of the one or more additional variations of the app information page. For example, treatment 202 may be a default treatment that is provided to users in an app store, whereas treatment 204 is a new treatment that the developer wishes to offer to a subset of users to test the attractiveness, or response rate, of the variation of the treatment. As such, a developer may provide multiple treatments of a same pp in the app store to different users. Moreover, by doing so, the app store can track a response rate to the different treatments. For example, the app store may track download rate among users that land on each of the variations of the app information page, time spent on the app information page for each treatment, a share rate for each treatment, and the like. As an example, a developer may be able to track that over a particular time period, the first treatment 202 in the app store resulted in a 1.9% download rate of the app, whereas the second treatment 204 in the app store resulted in a 2.5% download rate of the app. For purposes of this disclosure, a download rate refers to a percentage of views of a particular treatment of the presentation version of the app information page that resulted in a user downloading the app, for example by requesting download through a download icon 210 or 224 in the app information page in the app store.

As another example, the developer can track a share rate of the app, for example to determine how “viral” a particular presentation version of the app in the app store becomes. For example, users 200 presented the first treatment of the app may “share” the app information page 202 at a rate of 0.5% over a particular time period, whereas users 200 presented with the second treatment of the app may “share” the app information page 204 at a rate of 1.2%. For purposes of this disclosure, a share rate refers to a percentage of views of a particular treatment of the presentation version of the app information page that resulted in a user sharing the app, for example by sending a link to the app information page to another user, such as through a share icon 212 or 226 in the app information page in the app store. According to some embodiments, an additional user who is the recipient of the share may be directed to a same presentation version as the presentation version from which the information page was shared. For example, metadata may be embedded in the share link to indicate a particular presentation version. Alternatively, a different presentation version may be provided, either randomly, or through a predetermined rule set. In some embodiments, the app store may provide the developer with a user interface presenting information about performance about the various treatments, such as download rate and share rate of the various treatments. Additionally, or alternatively, the user interface may include other statistics, such as referral traffic (e.g., visits to one or more variants of the information page from a share or direct URL), a confidence value that a particular treatment “performs” better (i.e., satisfies a predetermined threshold performance rate based on download rate, share rate, referral traffic, and/or the like), an estimated lift rate indicative of a predicted rate at which a particular treatment improves upon the performance of a default treatment, and/or one or more confidence values related to the various prediction rates.

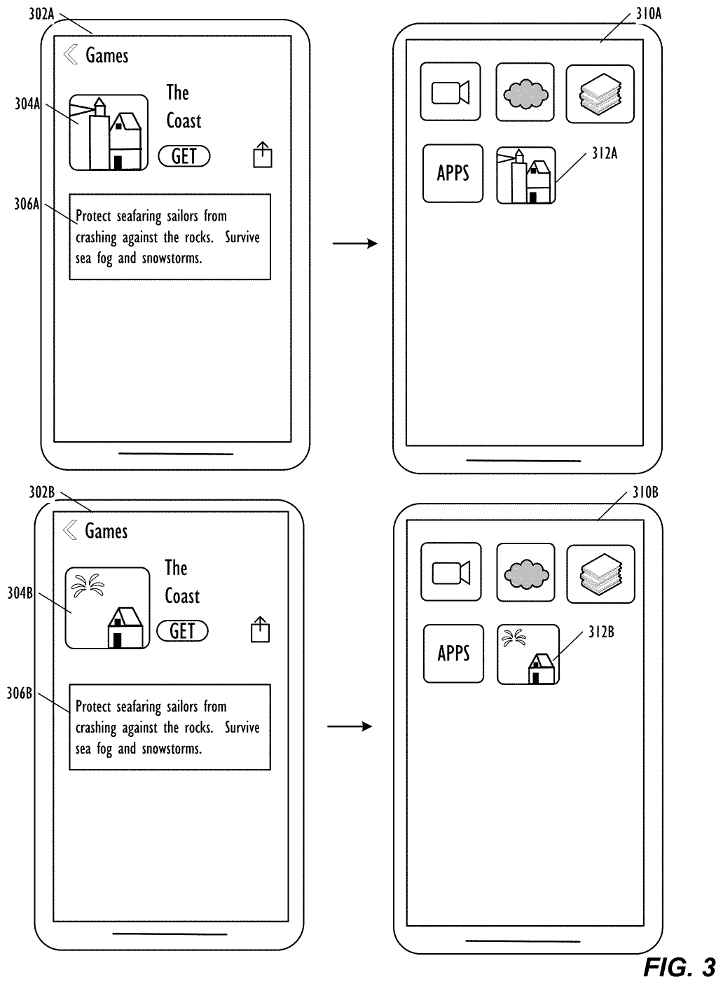

According to some embodiments, a user's experience with an app should remain consistent from within the app store to the actual experience of the app once it is downloaded and/or launched on a user device. FIG. 3 depicts an example flow diagram of how the presentation treatment remains consistent outside the app store, after download and/or launch of the application.

In FIG. 3, a first user may be presented a first treatment 302A of an information page of an app, while a second user is presented a second treatment 302B of an information page of the same app. As shown in the example of FIG. 3, the first treatment 302A presented on a first user device shows a first version of the icon 304A of the game called “The Coast,” as well as a first version of a description 306A. At the same time, the second treatment 302B presented on a second user device shows a second version of the icon 304B of the same game, as well as a second version of a description 306B. According to some embodiments, download of the game from either presentation version results in the download of a same binary download package. For example, the download package associated with either app information page may be identical, with the various presentation elements embedded.

In some embodiments, the user experience with the downloaded app should remain consistent when the app is installed and launched. As such, as shown at desktop 310A an icon 312A is presented that maintains consistency with the icon 304A presented in the app information page 302A from which the app was downloaded. Similarly, at desktop 310B, an icon 312B is presented that maintains consistency with icon 304B presented in the app information page 302B from which the app was downloaded. For example, a same icon that was presented to the user to represent the app information page in the app store may be configured to be presented on the user's desktop upon download and installation of the app on the user device. Other app information may be presented consistently from the information page in the app store and the installed application, such as screenshots, text, and other media.

FIG. 4 depicts a flowchart of a technique for providing variations on a product page to different users, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 400 begins at block 402 where access to an app store is detected from a first user identifier. In some embodiments, the app store access may be detected at the client device, such as the user device, or from a server, for example from the app store. The first user identifier may be associated with a user account identifier, a device identifier, or the like. In some embodiments, the access may be detected upon a user linking directly to an application information page for a particular application within the store, as a result of a search query within the store resulting in a listing for the application within the app store, or the like.

The flowchart 400 continues at block 404, where a representation version of a first application is selected for the first user identifier. As described above, a particular presentation version may be selected at random from among multiple presentation versions, or may be selected according to a rule set. For example, a certain percentage of users may be determined to be presented with certain treatments of a particular application. As another example, characteristics of a particular user may be tied to a rule to provide a particular treatment for that user. In some embodiments, the treatments provided to various users may be tracked in a data structure by the app store so that if another access is detected for the same application by the same user and/or device, the same treatment will be presented. In addition, by tracking the association of treatments to user identifiers, statistics can be collected and provided to the developer.

At block 406, a representation of the first application to be displayed in the app store based on the selected presentation version. The presentation version may be associated with a particular treatment, and may include a particular icon, description, and/or media item presented in the information page for the application. As such, the view of the app information page for one user may differ from the view of the app information page for another user.

The flowchart continues at block 408, where selection of the first application is detected from the app store via the representation. Selection of the application may include, for example, download of the application, a share request for the application, and the like. In some embodiments, the selection may occur within an app information page for the app, from an interface including a list of multiple apps along with a representation of the app (i.e., a search query result where the app is presented in the query result page in accordance with the particular visual representations of the treatment associated with the particular user). At block 410, the application is caused to be downloaded. The application may be downloaded, for example, in response to a detection of selection of a download request from within the app store. According to some embodiments, a download package including a binary file will be transmitted from the app store 100 to a requesting client device in response to the download request. Further, according to one or more embodiments, the binary file may be the same for two users who request to download a same app from different treatments of the app information page for the app in the app store.

The flowchart concludes at block 412 where the application is presented at the device in accordance with the presentation version. In some embodiments, user experience with the app remains consistent from the view within the app store to the use of the app on the user device. Accordingly, variations of the app presented in the app information page in the app store are maintained for the user when the user launches the application on a local device. In some embodiments, the particular treatment of the app for a particular user is tracked by the app store 100, for example in storage 104, the app store can communicate to the client device the particular treatment components to propagate throughout the app, such as icon, description, color scheme, media items, and the like.

According to some embodiments, techniques are provided for a custom information page for an app. Different app information pages may be provided to different users. According to some embodiments, the app store 100 may have the capability to generate and/or present multiple information pages for a single application. In some embodiments, the particular product page provided for a particular product may be selected in accordance with some contextual information for the request for the product page by the client device. For example, the particular media or layout provided may be selected in accordance with traits of the request, such as a location (on the internet and/or physical location) from which the request is received, or the like. In some embodiments, each of the custom app information pages may be associated with a unique URL such that an app information page reached from a first website link may differ in presentation from a second app information page reached from a second website link. According to some embodiments, the first app information page and second app information page may each include an option to download the app. The downloaded material may be the same from the download request from either the first app information page or the second app information page.

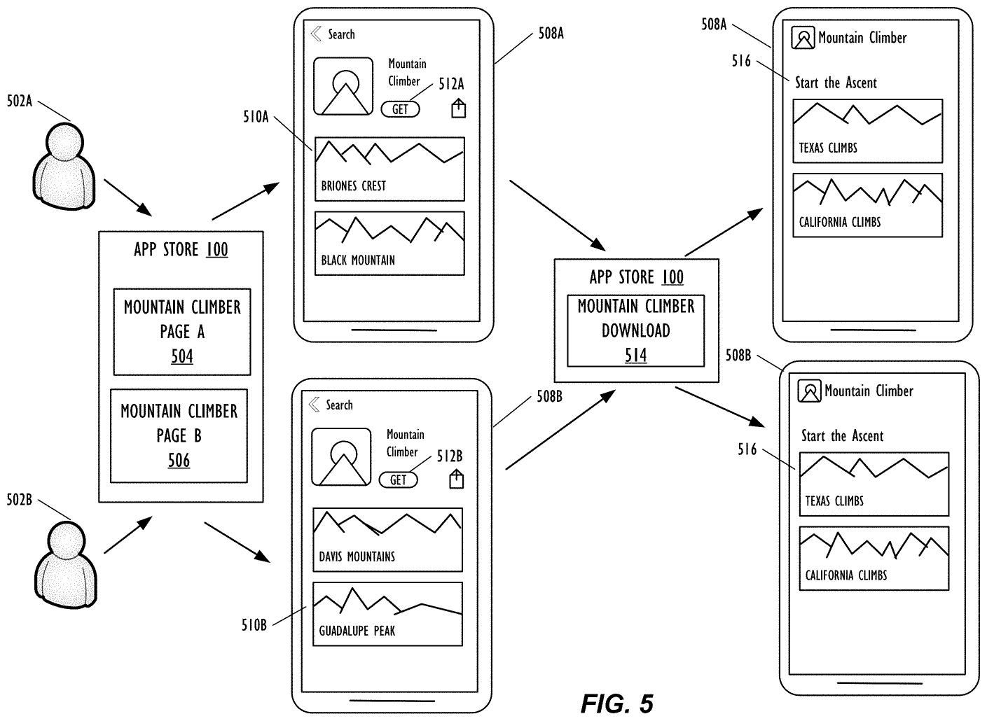

FIG. 5 illustrates, in flow diagram form, a technique for providing custom app information pages for various users. The flow diagram begins with two users 502A and 502B accessing an app information page in an app store 100 for an app called “Mountain Climber.” According to one or more embodiments, each of the users may request access to the Mountain Climber information page with different contextual information. For example, the first user 502A may access the app store 100 from a first internet location, while a second user 502B may access the app store 100 from a second internet location. In some embodiments, the first user 502A may access the app store 100 from different URLs. For example, first user 502A may click on a URL for a first app information page 504 for the Mountain Climber app, whereas the second user 502B may click on a different URL for a second app information page 506 for the same Mountain Climber app. As such, the app store 100 may be configured to manage multiple app information pages for a single app. As such, the first user 502A may view a first presentation version 510A of the Mountain Climber app in a first device 508A, whereas the second user 502B may view a second presentation version 510B of the Mountain Climber app in the second device 508B. For example, Mountain Climber Page A 504A may be a stored version of the first app information page 510A, whereas Mountain Climber Page B 504B may be a stored version of the second app information page 510B. As such, the media items in the first presentation version 510A differ from the media items presented in the second presentation version 510B. In some embodiments, the presentation versions may have different app preview presentations, screenshot presentations, text presentations, and the like, within an app information page.

Notably, each of the first app information page 510A and second app information page 510B may each include a user-selectable option to download the Mountain Climber app to the local device. For example, the first app information page 510A may include a download interface component 512A, whereas the second app information page 510B may include a download interface component 512B. According to one or more embodiments, when either the download interface component 512A or the download interface component 512B are selected, the Mountain Climber App is downloaded from the app store 100 as the Mountain Climber Download 514. That is, according to one or more embodiments, the download selection of each of the variations of the app information page causes the download of the same download package. Accordingly, as shown at 516 in the first device 508A and 508B may download and deploy the same app. Further, in some embodiments, the launched app may appear the same on either device.

FIG. 6 illustrates, in flowchart form, a technique for providing multiple app information pages for a particular app in an app store, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIGS. 1 and 5.

The flowchart 600 begins at block 602, where a trigger event is detected at a first device to launch a user interface for ap application within an app store 100. For example, the user interface may be an app information page for a particular app in the app store. The triggering event may be, for example, a user may select a link for a URL which navigates to one of the presentation versions of the app information page. As another example, a triggering event may include a search query for which results include a particular app.

The flowchart 600 continues at block 604 where one or more contextual parameters are identified in association with the interaction. The contextual parameters may include, for example, concurrently presented content may be considered when a download request is received. As an example, returning to FIG. 5, if the first user 502A navigates to an app information page for the Mountain Climber App from a page about California mountain climbs, the first presentation version 510A will be presented, which highlights California climbs. By contrast, if the second user 502B navigates to an app information page for the Mountain Climber App from a page about Texas mountain climbs, the second presentation version 510B will be presented, which highlights Texas climbs. Further, in some embodiments, as shown at 606, each presentation version may be associated with a unique URL. The app store may identify the particular URL for the presentation version of the app information page. Then, at block 608, a presentation version of the information page is determined for the first application. The presentation version may be determined from among a plurality of versions of an app information page. For example, the app store may host a default app information page for a particular app, and/or may host one or more variations of an app information page for a particular app.

The flowchart continues at block 610 where an information page for the first application is caused to be displayed, for example by the app store 100, based on the determined presentation version. In some embodiments, the various presentation versions may include different variations on an app preview presentation, a screenshot presentation, a text presentation, and/or the like. In one or more embodiments, a particular presentation version may be accessed from the app store 100 and provided to a client device, such as client device 107 or 109.

At block 612, a download request is received for the application via the presentation version at a particular client device. For example, as described above, the app information page may include a user interface component which, when selected, causes the app to be downloaded to the client device. The flowchart 600 concludes at block 614, where the first application is provided for download in accordance with the download request. According to one or more embodiments, the download package may be the same regardless of the presentation version from which the download request is received. Further, the installed application may be consistent across user devices regardless of the presentation version from which the download request is received.

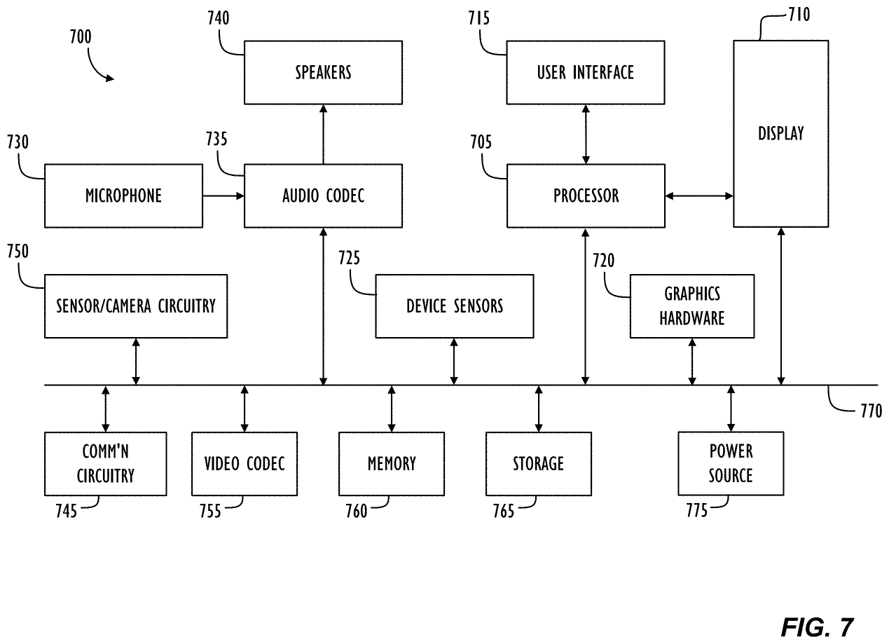

Referring now to FIG. 7, a simplified functional block diagram of an illustrative programmable electronic device 700 for providing access to an app store is shown, according to one embodiment. Electronic device 700 could be, for example, a mobile telephone, personal media device, portable camera, or a tablet, notebook or desktop computer system. As shown, electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, image capture circuit or unit 750, which may, e.g., comprise multiple camera units/optical sensors having different characteristics (as well as camera units that are housed outside of, but in electronic communication with, device 700), video codec(s) 755, memory 760, storage 765, and communications bus 770.

Processor 705 may execute instructions necessary to carry out or control the operation of many functions performed by device 700 (e.g., such as the generation and/or processing of DAs in accordance with the various embodiments described herein). Processor 705 may, for instance, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may view a captured video stream and/or indicate particular images(s) that the user would like to capture or share (e.g., by clicking on a physical or virtual button at the moment the desired image is being displayed on the device's display screen).

In one embodiment, display 710 may display a video stream as it is captured while processor 705 and/or graphics hardware 720 and/or image capture circuitry contemporaneously store the video stream (or individual image frames from the video stream) in memory 760 and/or storage 765. Processor 705 may be a system-on-chip such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs).

Image capture circuitry 750 may comprise one or more camera units configured to capture images, e.g., in accordance with this disclosure. Output from image capture circuitry 750 may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705, graphics hardware 720, and image capture circuitry 750 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods described herein. Power source 775 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 700.

In the foregoing description, numerous specific details are set forth, such as specific configurations, properties, and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

In the following description and claims, the terms “coupled” and “connected,” along with their derivatives, may be used. It should be understood that these terms are not intended as synonyms for each other. “Coupled” is used herein to indicate that two or more elements or components, which may or may not be in direct physical or electrical contact with each other, co-operate or interact with each other. “Connected” is used to indicate the establishment of communication between two or more elements or components that are coupled with each other.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing system, that manipulates and transforms data represented as physical (electronic) quantities within the computer system's registers and memories into other data similarly represented as physical quantities within the computer system memories or registers or other such information storage, transmission or display devices.

Embodiments described herein can relate to an apparatus for performing a computer program (e.g., the operations described herein, etc.). Such a computer program may be stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

Although operations or methods are described above in terms of some sequential operations, it should be appreciated that some of the operations described may be performed in a different order. Moreover, some operations may be performed in parallel, rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components. Thus, it will be evident that various modifications may be made thereto without departing from the broader spirit and scope of at least one of the disclosed concepts set forth in the following claims. The specification and drawings are, accordingly, to be regarded in an illustrative sense, rather than a restrictive sense.

In the development of any actual implementation of one or more of the disclosed concepts (e.g., such as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the disclosed concepts set forth in the embodiments described herein. Such development efforts might be complex and time-consuming, but may still be a routine undertaking for a person having ordinary skill in the art in the design and/or implementation of one or more of the inventive concepts set forth in the embodiments described herein.

As described above, one aspect of the present technology is the gathering and use of data available from various sources to improve the delivery to users of apps in an app store. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine the most useful version of an app information page for users of an app store. Accordingly, use of such personal information data enables users to have more streamlined and meaningful control of their experience with the app store and apps hosted by the app store. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of personalized app information pages, the present technology can be configured to allow users to select to “opt in” or “opt out” of participation in the collection of personal information data during registration for services or anytime thereafter. In another example, users can select not to provide their content and other personal information data for improved content sharing suggestion services. In yet another example, users can select to limit the length of time their personal information data is maintained by a third party, limit the length of time into the past from which content sharing suggestions may be drawn, and/or entirely prohibit the development of a knowledge graph or other metadata profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be suggested for sharing to users by inferring preferences based on non-personal information data or a bare minimum amount of personal information, such as the quality level of the content (e.g., focus, exposure levels, etc.) or the fact that certain content is being requested by a device associated with a contact of the user, other non-personal information available to the app store, or publicly available information.

As used in the description above and the claims below, the phrases “at least one of A, B, or C” and “one or more of A, B, or C” include A alone, B alone, C alone, a combination of A and B, a combination of B and C, a combination of A and C, and a combination of A, B, and C. That is, the phrases “at least one of A, B, or C” and “one or more of A, B, or C” means A, B, C, or any combination thereof, such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Also, the recitation of “A, B, and/or C” is equal to “at least one of A, B, or C.” Also, the use of “a” refers to “one or more” in the present disclosure. For example, “a DA” refers to “one DA” or “a group of DAs.”

What is claimed is:

1. A method, comprising:
detecting first access to an app store, wherein the first access is associated with a first user identifier;
selecting a first presentation version of a first application for the first user identifier, wherein the first application is associated with a plurality of presentation versions;
causing a representation of the first application to be displayed in the app store in accordance with the selected first presentation;
detecting selection of the first application for download from the app store; and
causing the first application to be downloaded,
wherein, upon launching the application, the application is presented in accordance with the first presentation version.

2. The method of claim 1, wherein the first user identifier is at least one of a device identifier and a user account identifier.

3. The method of claim 1, further comprising, in accordance with detecting selection of the first application for download from the app store, updating an engagement metric in associated with the first presentation version.

4. The method of claim 3, wherein the updated engagement metric is provided in a user interface for presentation to a developer associated with the application.

5. The method of claim 1, wherein access to the app store associated with a second user identifier causes a representation of the application in the app store to be presented in accordance with a second presentation version of the plurality of presentation versions.

6. The method of claim 5, wherein a download package associated with the first presentation version is the same as a download package associated with the second presentation version.

7. The method of claim 6, wherein, upon launching the application by the second user identifier, the application is presented in accordance with the second presentation version.

8. The method of claim 1, further comprising:
in accordance with detection of an updated default presentation version among the plurality of presentation versions, cause the representation of the application to be presented.

9. The method of claim 1, wherein the first presentation version is selected using a randomized selection process.

10. The method of claim 1, wherein the first presentation version is selected based on a predefined association between the user identifier and the first presentation version.

11. A non-transitory computer readable medium comprising computer readable code executable by one or more processors to:
detect first access to an app store, wherein the first access is associated with a first user identifier;
select a first presentation version of a first application for the first user identifier, wherein the first application is associated with a plurality of presentation versions;
cause a representation of the first application to be displayed in the app store in accordance with the selected first presentation;
detect selection of the first application for download from the app store; and
cause the first application to be downloaded,
wherein, upon launching the application, the application is presented in accordance with the first presentation version.

12. The non-transitory computer readable medium of claim 11, wherein the first user identifier is at least one of a device identifier and a user account identifier.

13. The non-transitory computer readable medium of claim 11, further comprising computer readable code to, in accordance with detecting selection of the first application for download from the app store, update an engagement metric in associated with the first presentation version.

14. The non-transitory computer readable medium of claim 13, wherein the updated engagement metric is provided in a user interface for presentation to a developer associated with the application.

15. The non-transitory computer readable medium of claim 11, wherein access to the app store associated with a second user identifier causes a representation of the application in the app store to be presented in accordance with a second presentation version of the plurality of presentation versions.

16. A method comprising:
detecting a first user interaction with a first device, wherein the first user interaction is a trigger event to launch a user interface for a first application within an app store;
identifying one or more first contextual parameters associated with the user interaction;
causing a first presentation version of an information page for the first application to be presented at the first device in accordance with the one or more first contextual parameters,
wherein the first presentation version of the information page is selected from a plurality of presentation versions for the first application;
receiving a download request for the first application from the first presentation version of the information page; and
providing the first application for download to the first device in accordance with the download request.

17. The method of claim 16, further comprising:
detecting a second user interaction with a second device, wherein the second user interaction is a second trigger event to launch an information page for the first application within the app store;
identifying one or more second contextual parameters associated with the second user interaction; and
causing a second presentation version of the information page for the first application to be presented at the second device in accordance with the one or more second contextual parameters.

18. The method of claim 17, wherein the first presentation version and the second presentation version comprise different variations of at least one selected from a group consisting of an app preview presentation, a screenshot presentation, and a text presentation.

19. The method of claim 18, further comprising:
receiving a download request for the first application from the second presentation version of the information page by the second device; and
providing the first application for download to the second device in accordance with the download request.

20. The method of claim 19, wherein a download package associated with the first download request is the same as a download package associated with the second download request.
